(19) United States
(12) Patent Application Publication
(10) Pub. No.: US 2012/0187188 A1
(43) Pub. Date: Jul. 26, 2012

(54) Ballot Tabulation Device with Internal Tote Bin

(76) Inventors: James E. Schmidt, Omaha, NE (US); Steve Bolton, Clearwater, FL (US)

(21) Appl. No.: 13/011,227

(22) Filed: Jan. 21, 2011

(51) Int. Cl. G07C 13/02

(52) U.S. Cl. 235/386

(57) ABSTRACT

A ballot tabulation device with internal tote bin includes a ballot box having a main compartment for receiving ballots and a tote bin configured to fit securely within an inner cavity of the main compartment. A ballot receptacle in the main compartment receives ballots and directs them downwardly into the tote bin so that the ballots stack into the tote bin. The tote bin includes two hingedly attached flaps that open upwardly to rest against the sides of the internal cavity to form a hopper-like receptacle for the ballots. The tote bin may also include one or more locking mechanisms to secure the lid flaps, and a telescoping handle and wheels for transporting the bin. In an alternative embodiment, a sensor in the inner cavity detects the presence of ballots in the tote bin and provides an alert to an operator when the tote bin is nearly full.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to a ballot tabulation device, and more particularly to a ballot tabulation device having an internal tote bin.

2. Description of Related Art

Paper ballots are widely used in elections, with markings indicating desired selections of a voter placed onto the ballot by the voter for tabulation by election officials. The marked ballots are typically presented into a ballot tabulation and ballot box device which electronically accumulates and/or transfers information relating to the selections marked on the ballot, the device also physically stores the ballots after they are tabulated. Known ballot tabulation devices include a scanner operable to optically scan the markings on the paper ballot and a ballot box to receive and safely store the ballots at the polling sites before those ballots are transferred to a central location for processing and/or storage.

Ballot boxes typically receive scanned ballots into a large inner cavity, with the ballots simply falling into the cavity after they are scanned. Because the inner cavity must be sized to store a large number of ballots, the ballots falling into the inner cavity often become misaligned and disorganized, making removal and collation of the ballots difficult and time consuming. At the close of the polling place or when the ballot box becomes too full, the loose ballots must be collected and placed into transfer boxes for transfer to a central location and/or storage. The disorganized ballots must be manually removed from the ballot box, straightened or aligned, and placed into a ballot-sized transfer box, requiring extensive handling and arrangement of the ballots.

### BRIEF SUMMARY OF THE INVENTION

A ballot tabulation device in accordance with an exemplary embodiment of the present invention comprises a ballot box having a main compartment for receiving ballots and a tote bin configured to fit securely within an inner cavity of the main compartment. A ballot receptacle in the main compartment receives ballots from a scanner and directs the ballots downwardly into the tote bin such that the ballots fall into a stack in the tote bin.

In exemplary embodiments, the tote bin includes a lid comprised of two hingedly attached flaps that open upwardly and outwardly so that the flaps rest against opposite sides of the internal cavity of the ballot box to form a hopper-like receptacle for the ballots. The lid may further include a locking mechanism to allow the contents of the tote bin to be secured for transport. The tote bin may include alignment blocks positioned along the bottom edges of the side walls to direct the tote bin into the inner cavity of the main compartment of the ballot tabulation device and to prevent the tote bin from moving within the cavity, thus keeping the tote bin properly aligned to receive the ballots. The tote bin may also include a strap handle to allow easy removal of the bin from the inner cavity, and a telescoping handle and wheels to allow the bin to be easily transferred.

In an alternative embodiment, a sensor in the inner cavity of the ballot box is operable to detect the presence of ballots in the tote bin and provide an alert to an operator when the tote bin is nearly full.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a ballot tabulation device with internal tote bin in accordance with an exemplary embodiment of the present invention.

FIG. 2 is a cut-away, side view of a portion of the ballot tabulation device of FIG. 1 showing the path of a ballot from the scanner to the inner cavity of the ballot box.

FIG. 3 is a partial front view of the ballot tabulation device of FIG. 1 showing the bin door open and the internal tote bin within the inner cavity.

FIG. 4 is a view of the ballot tabulation device and tote bin of FIG. 3 with the lid flaps of the tote bin in an open position.

FIG. 5 is a partial top view of the ballot tabulation device of FIG. 1 showing the tote bin positioned in the inner cavity of the ballot box and the lid flaps of the bin open to form a hopper-like receptacle for ballots.

FIG. 6 is a top view of the tote bin of FIG. 5 showing the lid flaps closed and the locking mechanism on each flap.

FIG. 7 is a perspective view of the tote bin being transported by a user using the wheels and telescoping handle of the bin.

### DETAILED DESCRIPTION OF EXEMPLARY EMBODIMENTS

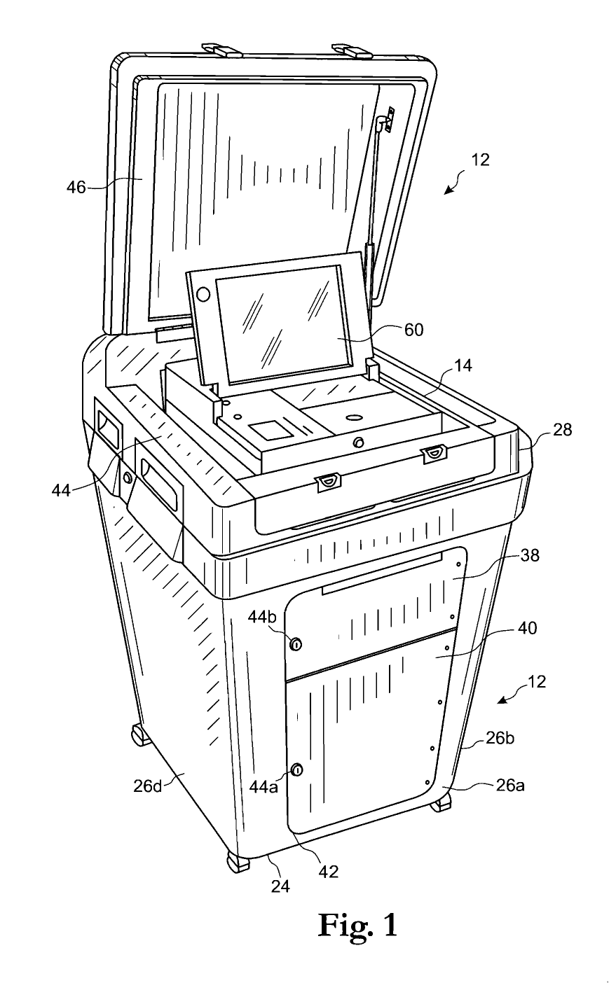

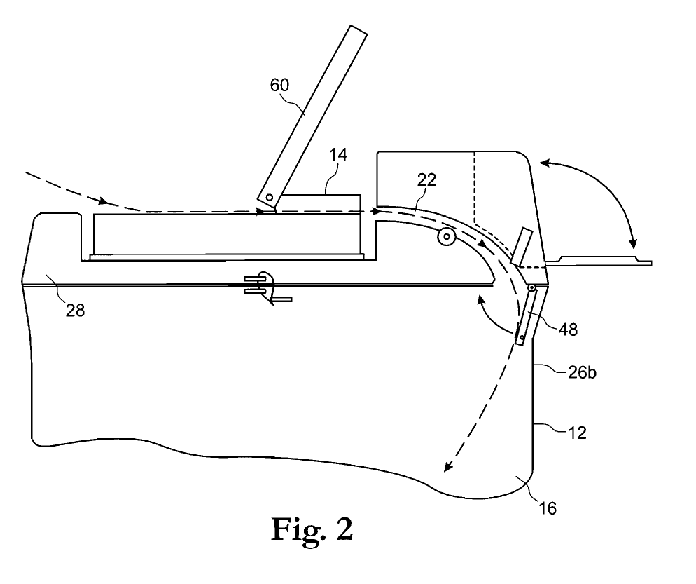

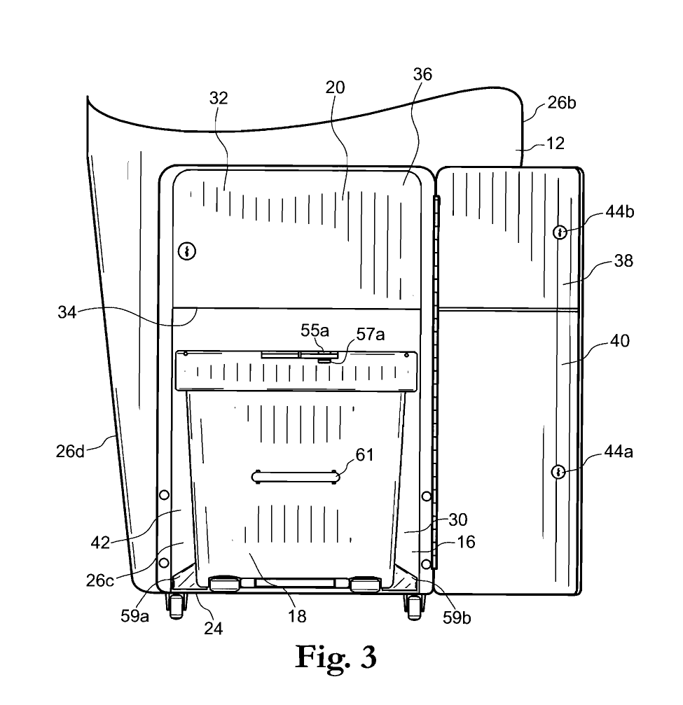

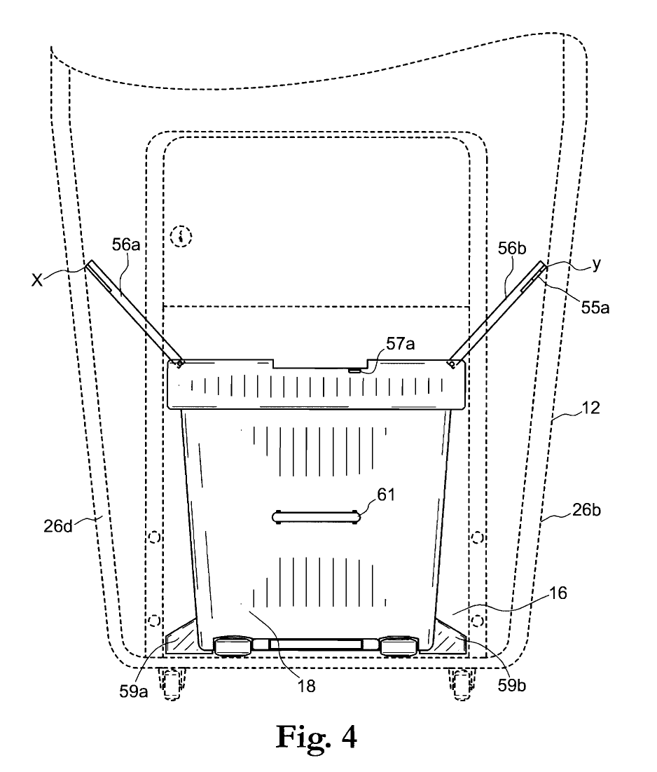

A ballot tabulation device in accordance with a first exemplary embodiment of the present invention is depicted in FIG. 1, indicated generally by numeral 10. The device includes a main compartment 12 for receiving ballots, and a scanner 14 positioned on top of the main compartment for scanning completed ballots. As shown in FIGS. 3 and 4, the inner cavity 16 of main compartment 12 houses a tote bin 18 that receives ballots deposited into the main compartment. Inner cavity 16 also houses an emergency ballot bin 20 that is used to store and secure ballots that cannot be scanned by scanner 14. As shown in FIG. 2, completed ballots scanned by scanner 14 are directed to a ballot receptacle 22 in the top wall of the main compartment 12, through the receptacle into inner cavity 16, and into tote bin 18. Tote bin 18 can be removed and transported to transfer and/or store the accumulated ballots. Each of the components and the operation will be described in more detail hereinbelow.

Referring to FIGS. 1-5, main compartment 12 comprises a generally square bottom 24, with the lower ends of side walls 26a, 26b, 26c and 26d joined to each side, respectively, of bottom 24. Top surface 28 is joined to the upper end of each of the side walls so that bottom 24, top surface 28, and side walls 26a, 26b, 26c, 26d form main compartment 12, with inner cavity 16 defined therein. A main ballot bin 30 is defined in the lower portion of inner cavity 16 by a ledge 34 extending across the inner cavity between side walls 26b and 26d. Ledge 34 further defines an emergency ballot bin 20 in the upper portion of inner cavity 16.

A bin opening 42 is defined in front side wall 26a, allowing access to the main ballot bin 30 and emergency ballot bin 20 in inner cavity 16. First and second doors 38 and 40 are attached via hinges to side wall 26a, along an edge of bin opening 42 such that each door is moveable between a closed position (enclosing the compartment's interior) and an open position allowing access to a portion of the interior. Each door includes a lock 44a, 44b for securing the respective door to prevent access to the inner cavity 16. Locks 44a, 44b may be any type of lock or locking mechanism known in the art. As best shown in FIG. 3, access to the main ballot bin 30 and emergency ballot bin 20 is separately allowed via doors 40 and 38, respectively. Emergency ballot bin 20 provides secure storage for ballots that cannot be read by scanner 14, or that are not accepted into the scanner.

As depicted in FIG. 1, top surface 28 comprises a case 44 having a hinged top cover 46 that can be lowered and latched to secure the scanner within the case. Alternatively, top surface 28 may be a generally flat surface or surface conformed to the profile of the scanner, with the scanner secured to the top surface. Looking to FIG. 2, top surface 28 includes a ballot receptacle 22 opening that directs a ballot received from scanner 14 into main compartment 12 for depositing into the tote bin contained therein. As depicted in FIG. 2, ballot receptacle 22 may include a hinged security door 48 to prevent ballots from exiting through the ballot receptacle. As also depicted in FIG. 2, the ballot receptacle provides a gently curved pathway to direct the ballot downwardly into inner cavity 16.

Scanner 14 preferably includes a screen 60 for displaying information to a user, such as candidate choices, voter selections, and confirmation messages to inform a voter that his/her ballot has been successfully scanned and deposited within main compartment 12. The screen is preferably a liquid crystal display “touch screen” having the capability to receive user inputs. Screen 60 is moveable between an open and a closed position, and preferably is lockable in its closed position. Preferably, scanner 14 includes a microprocessor electronically coupled with a memory storage device containing information to display on screen 60. Scanner 14 preferably has the capability to optically scan ballots and store the results on the memory storage device as an electronic image, most preferably in bitmap format. The memory storage device containing the information to display on screen 60 and the memory storage device for storing results of the optical scanner are preferably solid state memory devices, but it is within the scope of the invention for the memory storage devices to be any type of memory storage device such as hard drives, zip drives, or optical storage devices. Each memory storage device preferably may be inserted into a compartment within the scanner that has a locking lid to secure the compartment and prevent unauthorized removal of the respective memory storage device. Preferably, the scanner also includes a printer for printing an audit or event log of ballots scanned by the scanner. The scanner may also be connected to a network for transmitting the scanned results to a central computer. Preferably, scanner 14 is a model of scanner sold under the trade name “intElect DS200” or “DS200(i)” by Election Systems & Software, Inc. headquartered in Omaha, Nebr.

Looking to FIGS. 3 through 7, tote bin 18 comprises a generally rectangular bottom 50, with front 52a, back 52b, and left 52c and right 52d side walls connected along their adjoining edges and extending upwardly from bottom 50 to an upper perimeter 54, forming a bin opening at the top of the tote bin. Walls 52a, 52b, 52c, and 52d preferably extend approximately perpendicularly to bottom 50, most preferably the upper perimeter 54 is slightly larger than the interior surface of bottom 50 such that walls 52a, 52b, 52c, and 52d angle slightly outwardly as they extend upwardly, giving the walls a slight taper to permit ballots to fall more easily into the tote bin.

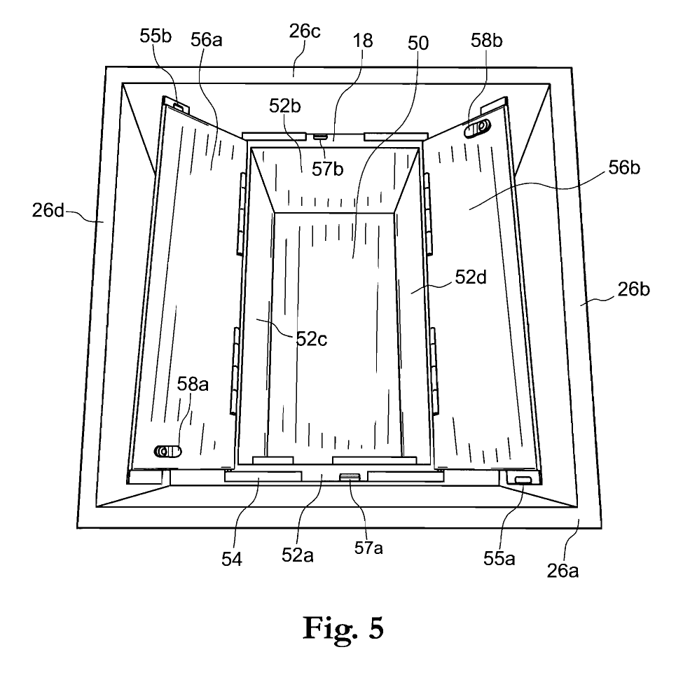

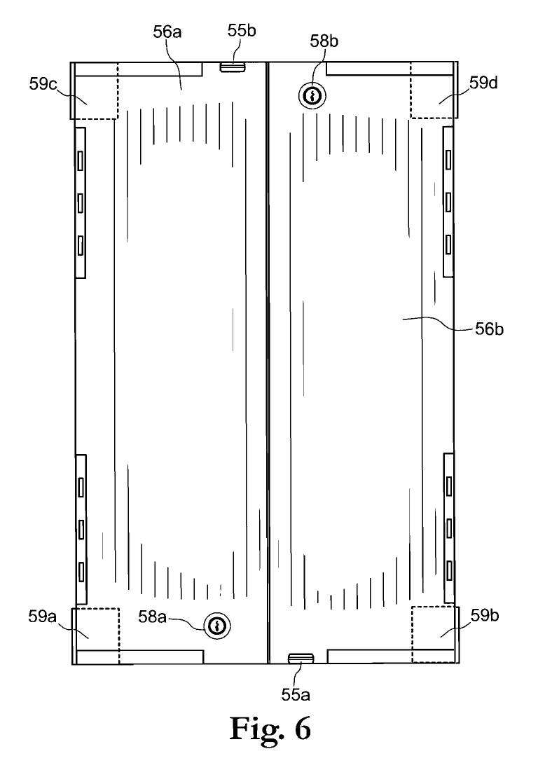

First and second flaps 56a, 56b are hingedly attached along an upper edge of side walls 52c, 52d, respectively, to form a lid for tote bin 18. Flaps 56a, 56b can thus be moved from a closed position, as depicted in FIGS. 3 and 6, to an open position, as depicted in FIGS. 4 and 5. With the flaps in the open position as depicted in FIG. 4, ballots inserted into inner cavity 16 fall into the tote bin. With the flaps in the closed position as depicted in FIG. 3, the ballots are secured within the tote bin and the tote bin may be removed from the main compartment. As seen in FIGS. 5 and 6, flaps 56a, 56b each comprise a locking mechanism 58a, 58b that is operable to secure the flap in a closed position. As best seen in FIGS. 3 and 4, flaps 56a, 56b further include seal slots 55a, 55b that align with corresponding seal slots 57a, 57b in the front and back 52a, 52b walls, respectively, of the bin when the flaps are in the closed position. With the flaps in the closed position, the aligned seal slots allow a seal—such as a zip-tie, strap, wire, band, or the like—to be inserted through the aligned slots to provide additional securement of the closed flap and to provide an indicator (if the seal is broken or opened) of potential tampering. Tote bin 18 is preferably formed from a strong, rigid, and lightweight material such as plastic or composite material.

As best seen in FIGS. 3-6, alignment blocks 59a, 59b, 59c, 59d are positioned near the bottom corners of the tote bin, along side walls 52c, 52d. As best seen in FIG. 3, the alignment blocks are sized and configured to fit closely to the sides of the main compartment 12 of the ballot tabulation device. The alignment blocks thus prevent the tote bin from sliding or skewing within the main compartment, securing the tote bin in proper alignment to receive deposited ballots.

Looking to FIG. 4, with the tote bin in position in the inner cavity and flaps 56a, 56b in the open position, the outermost edges of the flaps rest against the interior of side walls 26b, 26d of main compartment 12 so that the extended flaps form a hopper-like shape. As will be described in more detail hereinbelow, the angle of the flaps and the hopper-like arrangement further direct ballots entering the inner cavity into the tote bin.

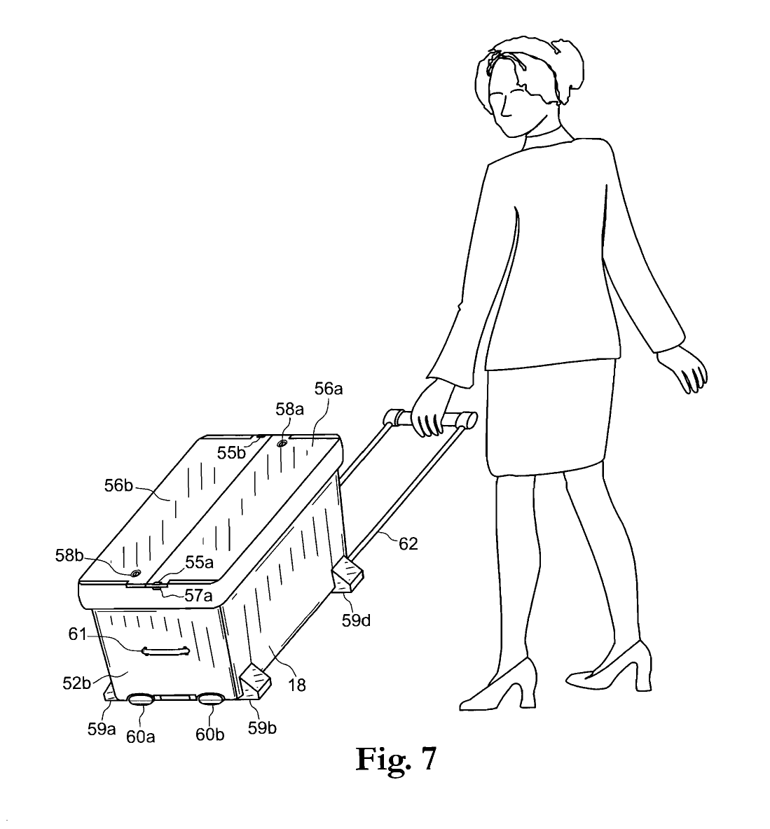

As shown in FIG. 7, tote bin 18 includes wheels 60a, 60b positioned along the junction of bottom 50 and back wall 52b and a telescoping handle 62 attached to bottom 50. Wheels 60a, 60b and handle 62 allow a user to remove the tote bin from the main compartment 12, and to transport the tote bin for transfer and/or storage with the ballots secured within the tote bin by flaps 56a, 56b and locking mechanisms 58a, 58b. Wheels 60a, 60b may be any type of wheel or roller device known in the art, such as those intended for use with luggage or containers. Similarly, telescoping handle 62 may be any type of handle known in the art, such as those used with luggage and the like. A strap handle 61 attached to the exterior surface of front wall 52a provides a grip and further allows a user to easily extract the tote bin from the main compartment.

### Operation

In operation, the ballot tabulation device with internal tote bin 18 is prepared for receiving ballots as follows. First, as seen in FIG. 1. Cover 46 is opened to expose the interior of the case 44. Preferably, scanner 14 is already locked inside of the case, if not, the scanner is installed and locked onto the case. Screen 60 of scanner 14 is positioned in its open position (as shown in FIGS. 1 and 2). Hinged security door 48 is opened, the scanner is powered-on and initialized, and the system is ready for use.

Looking to FIGS. 3 and 4, door 40 is unlocked and moved to its open position, and tote bin 18 is placed into inner cavity 16 of main compartment 12. As seen in FIG. 4, flaps 56a and 56b are lifted/rotated into their open position, with the outermost edges of the flaps resting against the interior of side walls 26b, 26d such that the flaps form a hopper-like receptacle into the tote bin. Door 40 is closed and locked, and the device is thus ready to receive ballots.

Looking to FIG. 2, a ballot is inserted into an opening on the front of the scanner 14. The ballot is pulled through the scanner via an internal drive mechanism, with an image of the ballot being scanned and recorded on a storage medium by the scanner before the ballot exits through the rear of the scanner. Upon exiting the scanner, the ballot passes into ballot receptacle 22 in the top of main compartment 12, through the gently curved path of the receptacle (as shown in FIG. 2), and into main compartment 12. Looking to FIGS. 4 and 5, ballots entering main compartment 12 will either fall directly into tote bin 18, stacking from the bottom of the bin, or may fall against flaps 56a or 56b, which will direct the ballots downwardly into the tote bin. Scanner 14 preferably displays a message indicating that the ballot was successfully accepted. If the scanner cannot read a ballot, then the scanner preferably returns the ballot to the user and displays a message to that effect to the user on screen 60, and indicates that the ballot should be reinserted into the scanner, replaced with a new ballot (if damaged), or, if the scanner is inoperable, deposited into the emergency ballot bin 20 Emergency ballots are processed by the poll workers at poll closing time according to the laws of the respective state the election is operating in.

When there are no more ballots to be processed by the scanner 14, screen 60 is closed and locked, and cover 46 closed and locked with the scanner secured inside. Door 40 is unlocked and tote bin 18 is removed from inner cavity 16 by grasping strap handle 61 and pulling the bin forward. Flaps 56a, 56b are closed and locked, and telescoping handle 62 is extended so that the entire tote bin and enclosed ballots can be transported to a desired location for processing, recording, and/or storage. Prior to securing the tote bin, any ballots in the emergency ballot bin 20 may be removed by the operator and inserted into the scanner 14 according to local and/or state rules. Alternatively, the ballots are placed into the tote bin for transport and further processing at the election central site.

If tote bin 18 becomes full and more ballots remain to be processed, the full tote bin 18 may be removed by unlocking and opening door 40, and replaced with an empty bin. The full tote bin may be transported for processing, recording, and/or storage.

### Alternative Embodiments

In normal operation, the status of the number of ballots processed and directed into the tote bin can be monitored by a counter displayed on screen 60 of scanner 14, or may be manually monitored by opening door 38 or 40 to view the ballots in the tote bin. In an alternative embodiment, inner cavity 16 of main compartment 18 is equipped with a proximity sensor operable to detect ballots in the tote bin. The proximity sensor is in electrical communication with the scanner, the scanner displays a message or alert on screen 60 when the ballots in the tote bin reach a predetermined level.

When the sensor detects that the tote bin is full and signals the scanner to display an alert, the operator removes and secures the full tote bin for transport as described above, and places an empty tote bin into the inner cavity as described above to allow further processing of ballots.

Preferably, the sensor is positioned in the upper portion of inner cavity 16 and directed downwardly to sense ballots in the tote bin. Other types of sensors known in the art may likewise be used to detect a presence or attribute of the ballots in the tote bin and to provide a signal to the scanner, such as infrared, acoustic, or capacitive technology sensors. Most preferably the predetermined level at which the sensor provides a signal to the scanner is adjustable.

From the foregoing it will be seen that this invention is one well adapted to attain all ends and objectives herein-above set forth, together with the other advantages which are obvious and which are inherent to the invention. For example, the ballot tabulation device with internal tote bin described herein is adapted to automatically and efficiently organize and stack ballots into a tote bin that provides for secure transport of ballots between a polling site and a central location. The configuration of the tote bin, with a shape conforming closely to the inner cavity of the ballot box and extendable flaps that form a hopper-like receptacle, provides for efficient accumulation and arrangement of ballots into the bin, with no or minimal sorting or collation required by an operator.

As used herein, the term “substantially”, “generally”, or any other similar qualifier used to modify a term shall be construed to permit variation in that term so long as the modification does not materially affect the operation of the described invention. For example, while bottom 24 of the main compartment has been described as “generally square”, it may permissibly vary from square so long as the variation does not affect the operation of the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub combinations are of utility and may be employed without reference to other features and sub combinations. This is contemplated by and is within the scope of the claims.

What is claimed and desired to be secured by Letters Patent is as follows:

1. A ballot tabulation device with internal tote bin, comprising:
a main compartment comprising at least one side wall extending between a top wall and a bottom wall to form an inner cavity there between, said main compartment further comprising a ballot receptacle configured to receive ballots and direct them into said inner cavity, and a bin opening configured to allow insertion and removal of a tote bin into said inner cavity;
a scanner positioned above said top wall, said scanner operable to direct ballots into said ballot receptacle; and
a tote bin comprising a bottom and upwardly extending side walls, said tote bin configured conform closely to said walls defining said inner cavity such that ballots received into said main compartment are directed into said tote bin.

2. The device of claim 1, wherein said ballot receptacle is positioned on said top wall of said main compartment and aligned with a ballot exit on said scanner such that ballots exit the scanner into the ballot receptacle.

3. The device of claim 1, wherein said tote bin comprises two flaps hingedly attached along opposing side walls, said flaps movable between a first, closed position and a second, open position.

4. The device of claim 3, wherein at least of said flaps and at least one of said side walls comprise a seal slot, wherein said flap seal slot and said side wall seal slot are aligned when said flap is in a closed position, said seal slots configured to receive a sealing device to secure and indicate tampering.

5. The device of claim 4, wherein said sealing device is a zip-tie, band, strap, wire, or a combination thereof.

6. The device of claim 5, further comprising a locking mechanism operable to secure said flaps in said closed position.

7. The device of claim 1, wherein said tote bin comprises at least one wheel positioned along a lower edge of said bin.

8. The device of claim 7, wherein said tote bin further comprises a telescoping handle.

9. The device of claim 1, further comprising a sensor positioned on said ballot box and operable to detect a presence of said ballots and provide an alert to an operator.

10. The device of claim 1, further comprising a door covering said bin opening, said door hingedly attached along an edge of said bin opening.

11. The device of claim 10, wherein said door comprises a locking mechanism operable to secure said door over said bin opening.

12. The device of claim 10, wherein said door comprises two separately operable partitions.

13. The device of claim 1, further comprising at least one alignment block affixed to a wall of said tote bin, said alignment block configured to position said tote bin securely within said main compartment.

14. The device of claim 1, further comprising a strap handle affixed to at least one of said side walls.

15. A ballot tabulation device with internal tote bin, comprising:
a main compartment comprising a top and a bottom connected by four side walls defining a generally rectangular inner cavity, wherein said top comprises a ballot receptacle configured to provide a ballot pathway between an exterior of said main compartment and said inner cavity; a scanner positioned on said top such that a ballot exit of said scanner is aligned with said ballot receptacle; and
a tote bin comprising a bottom affixed to upwardly extending side walls to form an open-top bin, and first and second flaps hingedly attached along a top edge of opposite side walls to form a lid.

16. The device of claim 15, wherein said first and second flaps are movable between a first, closed position covering said bin and a second, open position whereby said flaps are rotated upwardly and outwardly such that opposite outer edges of said flaps rest against opposite walls of said inner cavity.

17. The device of claim 16, wherein at least of said flaps and at least one of said side walls comprise a seal slot, wherein said flap seal slot and said side wall seal slot are aligned when said flap is in a closed position, said seal slots configured to receive a sealing device to secure and indicate tampering.

18. The device of claim 17, wherein said sealing device is a zip-tie, band, strap, wire, or a combination thereof.

19. The device of claim 18, further comprising a locking mechanism operable to secure said flaps in said closed position.

20. The device of claim 15, wherein said tote bin comprises at least one wheel positioned along a lower edge of said bin.

21. The device of claim 20, wherein said tote bin further comprises a telescoping handle.

22. The device of claim 15, further comprising a sensor positioned in said inner cavity and operable to detect a presence of said ballots and provide an alert to an operator.

23. The device of claim 15, further comprising at least one alignment block affixed to a wall of said tote bin, said alignment block configured to position said tote bin securely within said main compartment.

24. A ballot tabulation device with internal tote bin, comprising:
a main compartment defining an inner cavity, said main compartment including a ballot receptacle for receiving ballots;
a tote bin positioned in said inner cavity to receive ballots from said ballot receptacle, said tote bin comprising first and second flaps hingedly attached along a top edge of opposite side walls of said bin to form a moveable lid; and
a scanner coupled to said main compartment and positioned such that ballots exiting said scanner are directed into said ballot receptacle.

25. The device of claim 24, wherein said first and second flaps are movable between a first, closed position covering said bin and a second, open position whereby said flaps are rotated upwardly and outwardly such that opposite outer edges of said flaps rest against opposite walls of said inner cavity.

26. The device of claim 25, wherein at least of said flaps and at least one of said side walls comprise a seal slot, wherein said flap seal slot and said side wall seal slot are aligned when said flap is in a closed position, said seal slots configured to receive a sealing device to secure and indicate tampering.

27. The device of claim 25, further comprising a locking mechanism operable to secure said flaps in said closed position.

28. The device of claim 24, wherein said tote bin comprises at least one wheel positioned along a lower edge of said bin and a handle attached to a wall of said bin.

29. The device of claim 24, further comprising a sensor positioned in said inner cavity and operable to detect a presence of said ballots and provide an alert to an operator.

30. The device of claim 24, further comprising at least one alignment block affixed to a wall of said tote bin, said alignment block configured to position said tote bin securely within said main compartment.

31. The device of claim 24, further comprising a strap handle affixed to at least one of said side walls.
